(19) United States
(12) Patent Application Publication
(10) Pub. No.: US 2010/0209185 A1
(43) Pub. Date: Aug. 19, 2010

(54) ARRANGEMENT FOR CONNECTING AN ELONGATE ELEMENT TO A FURTHER COMPONENT

(75) Inventors: Rudolf Kirth, Vocklabruck (AT); Christoph Ebel, Bad Wimsbach-Neydharting (AT)

Correspondence Address: LOWE HAUPTMAN HAM & BERNER, LLP, 1700 DIAGONAL ROAD, SUITE 300, ALEXANDRIA, VA, 22314, US

(73) Assignee: TEUFELBERGER GESELLSCHAFT M.B.H., Weis (AT)

(21) Appl. No.: 12/667,489

(22) PCT Filed: Jul. 2, 2008
(86) PCT No.: PCT/AT08/00239

§ 371 Date: Apr. 28, 2010

(30) Foreign Application Priority Data
Jul. 3, 2007 (AT) A 1020/2007

(51) Int. Cl. F16B 7/00

(52) U.S. Cl. 403/292

(57) ABSTRACT

An arrangement (1) for connecting an elongate element (2) used in particular for absorbing and/or transmitting tensile and/or torsional forces to a further component (3) comprises a force introduction element (4) with a side facing the further component (3) and a side facing away from the further component (3) and an encasing element (5) having a closed cross-section, said encasing element encasing the force introduction element (4) at least in some sections and projecting over the force introduction element (4) on its side which faces away from the further component (3). Projections (6) are provided on at least one section of the force introduction element (4) on its outer surface facing the encasing element (5), said projections penetrating the encasing element (5) at least partially. The encasing element (5) consists essentially of a fibre composite material the fibre structure of which is produced in a braiding or winding process, wherein the fibres contained in the fibre composite material lie in continuous form at least partially in the regions formed between the projections (6). The projections (6) are present in a dense, regular arrangement at least in one region of the force introduction element (4) and the ratio of the height of the projections (6) to the diameter of the projections (6) is greater than 1, preferably greater than 2, in particular 3 and more.

The invention relates to an arrangement for connecting an elongate element used in particular for absorbing and transmitting tensile and/or torsional forces such as, for example, tensile elements for the rigging of sailing ships or torsional shafts to a further component.

The object of the invention is, in particular, to enable an improved force transmission particularly of fibre composite materials to a different material, in particular metal. A possible field of application therefor are tensile elements for sailing or surfing, wherein, on the one hand, high forces act upon the material and, on the other hand, the materials used have to be as lightweight as possible, but yet break-proof and tough. Tensile elements made of fibre composites or in the form of fibre ropes have turned out to be lightweight and loadable for this case of application. There are two basic possibilities to implement the introduction of force into such an element:

Fastening means formed in one piece with the tensile element such as terminal eyes are well suited for the introduction of force, however, the production of such integrally made tensile elements is very complex and expensive. The length of such an element is determined during manufacture, which requires piece production for each case of application.

The second possibility is using a force introduction element which is applied to the ends of the tensile element which has been cut into the desired length and can be connected to said element. In the prior art, this end piece consists virtually completely of metal and has a high weight. Metal is used in order to implement connection elements such as, e.g., a thread, which is not possible in sufficient strength with a fibre composite material. A connection between the composite fibre material and an appropriately designed metallic element is then necessary. However, said materials are connectable to each other only with difficulty, for which reason malfunctions due to material fractures occur again and again.

From WO 03/008702 A2, a system is known in which a tie rod is composed of several thin pultruded individual rods. In a metallic end terminal, the rods are arranged around a metal cone and grouted with resin. The cone is held in position by screwing in a counternut with an internal thread into which a support element can be screwed. The entire arrangement can be wrapped with fibres in order to counteract the cone's bursting force.

A disadvantage of said prior art is that the force transmission occurs in the arrangement by sticking together the pultruded rods. In particular in case of strong tensile forces, the stability of the connection can be ensured only if an adequate adhesive length is provided, which in turn requires the use of a very large and bulky end piece, which—since it is made of metal—has a high weight.

Furthermore, from WO 2006/012876 A1, a process for producing an end connection for fibre-reinforced rods made of thermoplastic material is known, wherein a rod is put into a bushing and is heated to such an extent that the matrix material softens. Then, a cone made of metal or also of a thermoplastic material is inserted into the rod end, thereby expanding said end. The fibres run around the cone and are compressed behind it. The rod end is thereby positively fixed in the end piece.

A disadvantage of this known prior art is in particular that the process is limited to the use of a thermoplastic matrix material and that also here a heavy metallic bushing is used.

WO 2004/113760 A1 discloses a connection of a parallel fibre rope to a bushing. The fibres of the rope are received in the cone-shaped bushing made of fibre-reinforced plastic and are pressed against the wall of the bushing by a central cone. The bushing is produced from a metal core in a winding process and consists of the same fibre material which also makes up the rope. In the exemplary embodiment according to WO 2004/113760, this is a PBO fibre. The cone has a rougher surface than the wall of the bushing so that the cone is drawn into the bushing when the rope is pulled. The bushing is in turn stuck with its rear part into a metal sleeve and is secured therein against slipping out by means of a nut which can be screwed in from behind.

High expenses for the manufacture of the connection are a disadvantage of this prior art. In addition, the mounting for the bushing is made of metal and thus has a high weight.

Further connection arrangements are known from documents DE 100 10 564 C1, WO 95/29308 A1, U.S. Pat. No. 6,886,484 B1, DE 39 42 535 A1, DE 40 30 319 A1, GB 2091770, U.S. Pat. No. 4,755,076, FR 376 395 A, U.S. Pat. No. 4,704,918 and U.S. Pat. No. 4,260,332.

WO 04/28731 describes the manufacture of structured surfaces provided with projections using an electron irradiation process.

It is the object of the invention to provide an arrangement for connecting an elongate element to a further component which enables a durable and highly loadable positive connection between the elongate element and the further component. Another crucial object of the invention is to contribute to a reduction in weight.

According to the invention, the object is achieved in that a force introduction element with a side facing the further component and a side facing away from the further component and an encasing element having a closed cross-section are provided, said encasing element encasing the force introduction element at least in some sections and projecting over the force introduction element on its side which faces away from the further component, wherein projections are provided on at least one section of the force introduction element on its outer surface facing the encasing element, said projections penetrating the encasing element at least partially. The encasing element consists essentially of a fibre composite material the fibre structure of which is produced in a braiding or winding process, wherein the fibres contained in the fibre composite material lie in continuous form at least partially in the regions formed between the projections. The projections are present in a dense, regular arrangement at least in one region of the force introduction element and the ratio of the height of the projections to the diameter of the projections is greater than 1, preferably greater than 2, in particular 3 and more.

Thus, the present invention provides a completely new concept for the connection of various kinds of elongate elements to a further component. By combining a surface of the force introduction element which is provided with projections, on the one hand, with an encasing element which consists essentially of a fibre composite material and has a closed cross-section, on the other hand, a firm connection is produced due to the fibres of the encasing element which run between the projections of the force introduction element.

Thus, the principle of the present invention is based not only on a bond, as known from some prior art documents, but also on an additional positive locking between the force introduction element and the encasing element. This improves the force transmission and facilitates the approval and testing of such a connection in contrast to a pure bond for which testing of the actual strength using nondestructive testing methods is very complex.

By densely arranging the projections, a better distribution of the introduction of force can be achieved as compared to prior art arrangements.

The connection of the elongate element occurs in that it is enveloped by the encasing element or formed in one piece therewith.

The term “consisting essentially of a fibre composite material” is supposed to clarify for the purposes of the present invention that the encasing element, aside from the fibre composite material, may exhibit additional outer layers which, for example, protect the fibre composite material from atmospheric influences etc..

The arrangement according to the invention can easily be produced by winding or braiding the fibre material of a fibre composite material around a force introduction element having a surface which exhibits projections so that the fibres lie in continuous form at least partially in the regions formed between the projections. Subsequently, the fibre composite material can be impregnated and hardened in a known fashion. Optionally, fibres which have already been preimpregnated may also be used for winding and braiding, respectively, so that only hardening still has to take place.

Thereby, the combination according to the invention of a surface provided with projections and a winding or braiding of fibre-reinforced plastic provides the advantage during production that the fibres can be deposited in the distances between the projections already during the manufacture by braiding and/or winding fibres around the surface and a very durable and loadable compound between two elements consisting of different elements can thus be formed.

In addition, the present invention allows component parts which so far have consisted of metal (e.g., metallic bushings) to be replaced at least partially by a substantially lighter-weight fibre composite material, depending on the concrete case of application.

Further advantageous embodiments of the invention become apparent from the subclaims.

According to a preferred exemplary embodiment, the elongate element may consist of the same material as the encasing element (i.e., may contain a fibre composite material) and may be formed in one piece with the encasing element. This permits a particularly cost-efficient production and notable savings in weight.

Thus, the elongate element may, for example, be a pipe consisting of a fibre composite material which, according to the invention, is connected on its end to an essentially cylindrical force introduction element so that the fibres of the fibre composite element run between the projections of the surface of the force introduction element.

In a further advantageous embodiment, the elongate element may be designed separately from the encasing element and, in use, may be surrounded by the encasing element at least in some sections, whereby it is possible to connect elongate elements of various kinds of materials to the further component.

The elongate element can, for example, be designed as a braided tensile element, as a pultruded rod or as a bundle of several pultruded rods.

If such an embodiment is chosen, advantageously the elongate element can likewise exhibit projections at least in a part of the section surrounded by the encasing element, which projections penetrate the encasing element at least partially so that force transmission can be assumed by both connection components.

In this embodiment, the elongate element can be designed, for example, as a bundle of several pultruded rods, wherein the projections can be formed by ends of the individual rods of the pultruded bundle of rods which are radially bent outwards. If the fibres of a fibre composite material are wound or braided around said outwardly bent ends, a firm connection between the elongate element and the fibre composite material is achieved.

This constitutes a very cost-efficient variant since the advantageous pultrusion process can be used for producing the elongate element, via which process elements with a precise shape reproduction, essentially completely oriented fibres and a smooth flat surface are producible.

It is particularly advantageous if the projections on the surface of the force introduction element are shaped in the form of pins, since this leads to the fibres being guided reliably in close contact to the surface around which they are to be braided and/or wound during braiding and/or winding.

The head shape of those pins may be chosen depending on the field of application; for example, the pins may exhibit ball-shaped expansions on their outwardly projecting ends.

Preferably, the diameter of the pins can range between 0.3 mm and 3.5 mm, preferably between 0.5 mm and 2.5 mm, particularly preferably between 0.8 mm and 1.6 mm.

Furthermore, at least one circumferential row of projections can preferably be formed on the force introduction element or on the elongate element, respectively, in order to permit a reliable grip of the composite fibre material. Those projections prove to be very beneficial particularly when the fibres of the fibre composite material are braided around the force introduction element, namely when the braiding direction and/or the winding direction is/are reversed, since the braid fibres are held in position by hooking into the projections and the braiding can no longer be removed from the core after the braiding direction has changed.

Advantageously, the projections can be distributed on the outer surface of the force introduction element or the elongate element, respectively, in the form of a regular pattern, which permits easy producibility. In doing so, the arrangement of the projections can be tailored according to the demands made on the introduction of force. Via the density of the projections it is possible to adjust the amount of force which is to be transmitted in a particular area of the overlapped region. Stress peaks can be attenuated and hence the load-bearing capacity of the entire compound can be improved.

The projections can be arranged randomly and/or with a density gradient and/or with a constant density so that the respective demands made on the finished element can be satisfied in every regard.

The dimensioning of the projections, on the one hand, and the respective distances between the projections, on the other hand, can be chosen depending on the field of application. Usually, the ratio of the distance between two projections to the diameter of the projections should be greater than 1, preferably at least 3. Said ratio can also assume values of 10 and more.

Particularly in case of pin-shaped projections, the ratio of pin height to pin diameter is preferably greater than 1, particularly preferably greater than 2 and can assume values of 3 and more.

The density of the projections on the force introduction element and optionally on the elongate element, respectively, can be at least 1 projection/cm², preferably between 5 and 20 projections/cm², particularly preferably between 8 and 15 projections/cm².

The projections provided on the force introduction element and optionally on the elongate element, respectively, can be formed in one piece with the force introduction element or the elongate element, respectively, or can be connected to the force introduction element or the elongate element, respectively, by welding, soldering, bonding, screwing or similar measures so that an easy and cost-efficient manufacture is possible.

Welding on pin-shaped projections according to the so-called cold metal transfer process constitutes a particularly preferred embodiment. The cold metal transfer process is known, for example, from WO 2006/125234 A1. This process allows pin-shaped projections of a desired diameter and with an adjustable length and head shape of the pin to be welded on in a quick and reproducible manner.

According to a further embodiment of the invention, an expander body is provided which spreads apart the elongate element on its end facing the force introduction element in a manner known per se and by means of which the elongate element is clamped in use between the expander body and the encasing element and/or the force introduction element. The main advantage of this variant is the easy and flexible installability of the connection.

It is furthermore advantageous if the force introduction element consists of a material selected from the group consisting of metal, plastic, fibre-reinforced plastic and ceramics, since this guarantees long durability.

The fibre composite material of the encasing element is advantageously made of a material selected from the group consisting of fibre-reinforced plastic, fibre-reinforced metal and fibre-reinforced ceramics, which materials are characterized by high elasticity and strength as well as low weight.

Furthermore, it is advantageous if the fibres used in the fibre composite material are selected from the group consisting of carbon fibre, glass fibre, aramide fibre, boron fibre, ceramic fibre, basalt fibre, PBO fibre or any combination of those fibres, since it is thus possible to optimally choose the fibres depending on the demands made on the material.

Advantageously, the force introduction element can taper toward its side facing away from the further component so that an improved force transmission of the surfaces of the force introduction element which adhere to each other, on the one hand, and of the elongate element, on the other hand, can be achieved by attenuation of stress peaks. The material of the force introduction element can deform further in the thin region and can adapt to the load and will absorb less force in this region. The thicker the material, the stiffer it gets, whereby the transition of force amplifies in this region. The stress distribution levels out throughout the entire area of the overlap.

Similarly, the encasing element can advantageously taper toward its side facing away from the further component, which also causes an attenuation of stress peaks and hence a more regular force transmission.

In a further embodiment, a connecting element can be provided on the end of the force introduction element facing the further component so that a quick and easy connection to the further component becomes possible.

Advantageously, the connecting element can be an eye, a flange, a toothed wheel or a thread or another common fastening element from mechanical engineering, which permits manifold possibilities of combination with screws, hooks, flanges and other elements.

In another preferred embodiment of the arrangement according to the invention, the fibre composite material of the encasing element is built up of more than one layer of fibre material, in particular of two layers. This means that, on a layer of fibre material which has been applied, at least one further layer of fibre material is applied which is deposited between the projections.

Below, preferred embodiments of the invention are illustrated in further detail with reference to the drawings.

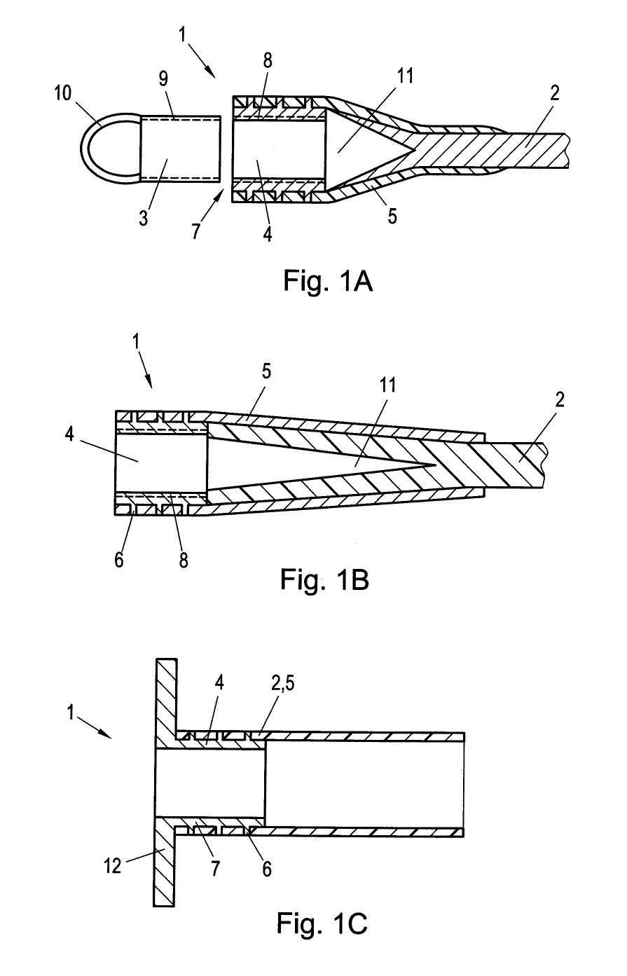

FIGS. 1A-1C show strongly schematized sectional views of three preferred exemplary embodiments of arrangements designed according to the invention for connecting an element to a further component,

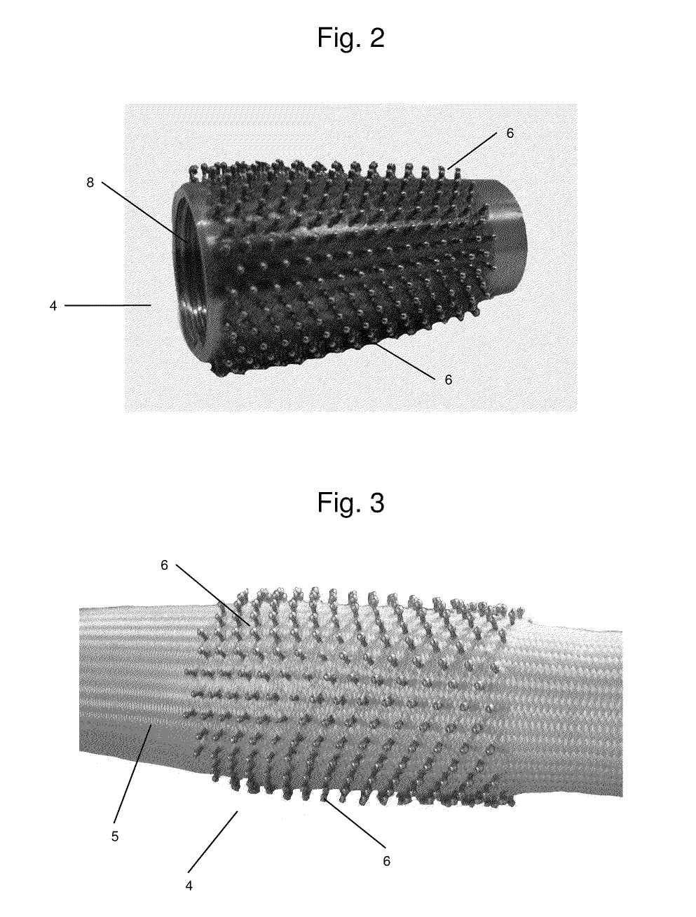

FIG. 2 shows a perspective illustration of a force introduction element for use in the arrangements of the invention according to FIGS. 1A to 1C,

FIG. 3 shows a perspective illustration of a force introduction element according to FIG. 2 with a partial braiding around it,

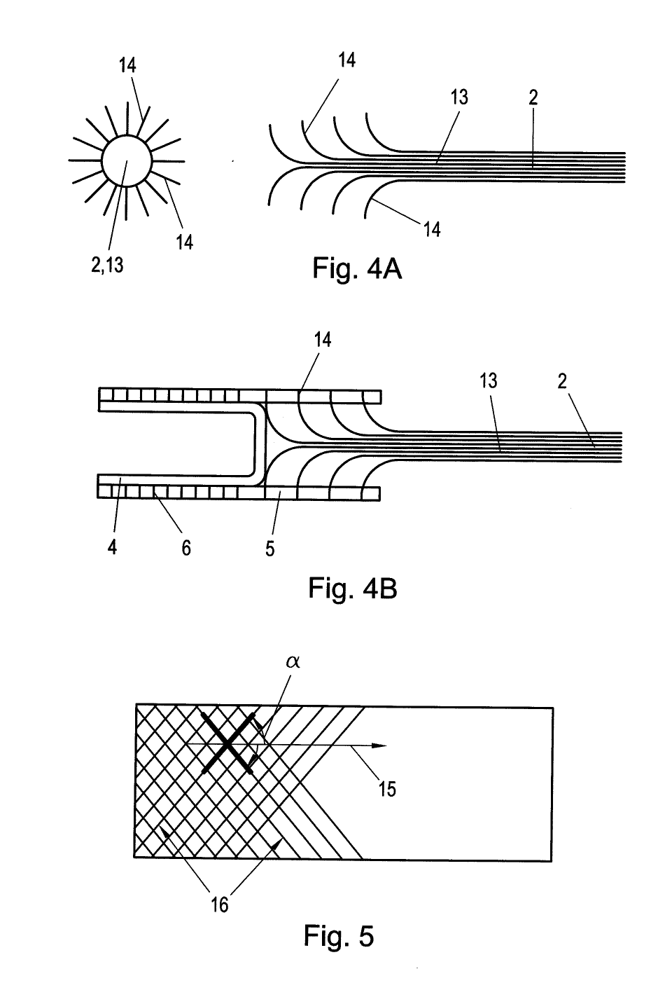

FIGS. 4A-4B show strongly schematized illustrations of a further preferred exemplary embodiment of an arrangement according to the invention comprising a bundle of pultruded rods, and

FIG. 5 shows a schematic illustration of the course of the fibres of the encasing element in a braiding around the force introduction element.

FIGS. 1A to 1C show strongly schematized sectional views of arrangements 1 according to the invention which are suitable for connecting an elongate element 2 used in particular for absorbing and transmitting tensile and/or torsional forces to a further component 3 via a frictional connection and positive locking.

The arrangements 1 according to FIGS. 1A to 1C each comprise a force introduction element 4 which has an essentially hollow cyclindrical design in the exemplary embodiments. The force introduction element 4 is connectable to the elongate element 2 by an encasing element 5 having a closed cross-section. The encasing element 5 essentially consists of a fibre composite material whose arrangement of reinforcing fibres is produced in the braiding and/or winding process.

Thereby, the force transmission between the force introduction element 4 and the encasing element 5 occurs by projections 6 arranged on an outer surface of the force introduction element 4 which faces the encasing element 5, in which the braiding and/or the winding structure of the encasing element 5 can become interlocked. The projections 6 penetrate the encasing element 5 at least partially and thus provide a connection between the elongate material 2 and the force introduction element 4, wherein the fibres contained in the fibre composite material of the encasing element 5 lie in continuous form at least partially in the regions formed between the projections 6 and recessed relative to the projections 6. The fibre direction of the fibres 16 of the encasing element 5 can be seen in lateral view in that the fibres enclose an angle cc with the longitudinal component direction 15 of the elongate element 2, with the angle being 0<α90°. This is schematically illustrated in FIG. 5.

As a result, a reliable transmission of tensile and torsional forces from the elongate element 2 into the fibre composite structure of the encasing element 5 and from there into the metallic force introduction element 4 is possible.

In this case, the fibre composite material is constructed in the form of a fibre braiding or a winding structure and is stabilized with a hardenable matrix material. The latter can be of a thermoplastic as well as of a duroplastic nature. The infiltration process of component parts can, for example, be an RTM (resin transfer moulding or transfer moulding) or another infusion process. For particular applications, metallic or ceramic matrix materials are conceivable as well.

Particularly carbon fibre, glass fibre, aramide fibre, boron fibre, ceramic fibre, basalt fibre, PBO fibre or any combination of those fibres come into consideration as the fibres used. Depending on the requirement, a person skilled in the art can choose the respective fibre which is appropriate.

In the exemplary embodiments illustrated in FIGS. 1A and 1B, the force introduction element 4 is provided with a connecting element 7 in the form of an internal thread 8 which permits connection to a further element 3 provided with an external thread 9. For clarification, in FIG. 1A, a lug 10 is moulded to the further element 3 by way of example. The connection can also be achieved via other suitable connecting elements 7 such as, for example, a bayonet connection. Devices formed in one piece with the force introduction element 4 such as eyes, flanges, toothed wheels etc. are possible as well.

The projections 6 can be welded on, but can also be connected in another way to the force introduction element 4, for example, by soldering, bonding, screwing or similar measures. Preferably, the projections are welded on according to the cold metal transfer process.

Furthermore, the possibility exists that the projections 6 are connected integrally to the force introduction element 4 if said element is, for example, a cast part or a milled component part.

In the embodiments according to FIGS. 1A and 1B, the encasing element 5 made of fibre composite material forms a truncated hollow body into which the elongate element 2 is inserted. The element 2 can be, for example, a rod made of a fibre-reinforced composite material with a thermoplast or duroplast matrix or also a rope or cable formed from fibres. In this case, the fibres can be present exclusively in the longitudinal direction or also in the form of a braiding or a twisted cable. Furthermore, the elongate element 2 can be formed of several individual elements.

The elongate element 2 is expanded in the interior of the truncated encasing element 5 in order to produce a positive locking with the encasing element 5. As can be seen, e.g., in FIGS. 1A and 1B, this can be effected by an expander body 11 inserted into the elongate element 2. It brings about a distribution of the fibres in the circumferential direction and results in a well-balanced fibre load.

In this way of designing an end connection of an elongate element 2, a major advantage of using an encasing element 5 the fibres of which are present as a braiding lies in the fact that the braiding contracts under tensile stress and thus exerts an increased retention force on the elongate element 2 in the area of the spreading. Furthermore, the fibres running continuously in the circumferential direction provide an excellent reinforcement against a bursting effect of the inserted expander body 11, since they are subject to tensile loading in an optimal way.

In doing so, the infiltration of the fibres of the encasing element 5, which fibres are present as a braiding or winding, with the matrix material can occur in an RTM (resin transfer moulding oder transfer moulding) or another infusion process such as, e.g., the vacuum infusion process. Thereby, it is conceivable that the fibre braiding of the encasing element 5 is hardened together with the metallic force introduction element 4 separately from the expander body 11 and the elongate element 2, and also that the infiltration occurs when the complete end connection has already been applied to the end of the elongate element 2 in order to achieve the braiding infiltration and a bonding with the inserted element 2 in one process step.

In addition, it is also possible that preimpregnated fibres are used for producing the braiding with a thermoplastic or duroplastic matrix material. An additional infusion step can thus be avoided. In case a duroplastic matrix is used, the component part must be hardened in a furnace or, respectively, in case a thermoplastic matrix is used, it must be heated to the softening temperature and thereupon be cooled in a suitable mould to such an extent that the matrix hardens.

A possibility which is illustrated in FIG. 1C as a further embodiment is that the elongate element 2 consists of the same material as the encasing element 5 and is formed in one piece with the encasing element 5, for example, as a rod made of fibre-reinforced plastic with a terminal force introduction element 4. In this way, the force introduction element 4 is integrated in the elongate element 2 during the manufacturing process thereof, which constitutes a particularly easy and thus cost-efficient variant.

In FIG. 1C, such an exemplary embodiment of an arrangement 1 designed according to the invention is illustrated. The elongate element 2 is here designed as a hollow shaft or pipe made of fibre composite material and hence is identical to the encasing element 5 in this exemplary embodiment. The illustrated element 2 can be one end of a shaft which is intended for the transmission of torsional forces. The integral production of the pipe with the flange neck 12, e.g., in a an RTM or infusion process, thereby leads to an excellent connection of the tubular elongate element 2 to the flange neck 12. Such a pipe made of a braiding is suitable in particular for the transmission of torsional loads, since the fibres can be oriented at an angle which is ideal for the force transmission. The connection of the torsional shaft occurs via the force introduction element 4 with a flange neck 12, which, like the force introduction element 4, is also manufactured from metal and formed in one piece with the force introduction element 4 or is connected to it in an appropriate manner such as, e.g., by welding, soldering etc..

In FIG. 2, a force introduction element 4 which is suitable for use with one of the arrangements according to FIGS. 1A to 1C is illustrated on an enlarged scale. In the exemplary embodiment, the force introduction element 4 is designed so as to be slightly tapered. However, it may also be designed cylindrically at least in some sections, as indicated in FIGS. 1A to 1C.

The force introduction element 4 preferably consists of metal, but may also consist of a high-strength plastic, a fibre-reinforced plastic or ceramics, depending on the case of application.

The projections 6 can be designed in various ways. A pin-like form is preferred, which is clearly visible in FIG. 2 and FIG. 3. The force introduction element 4 is illustrated alone in FIG. 2, the force introduction element 4 over which the encasing element 5 has already been braided partly is illustrated in FIG. 3. As has already been mentioned above, the projections 6 penetrate the fibre composite material of the encasing element 5 at least partially. In the exemplary embodiment, they protrude beyond it, their length is thus larger than the thickness of the fibre material which has been applied at this point in time. As a result, it is possible, for example, to apply a further layer of fibre material which is deposited between the projections. In this manner, the upper fibre layers, which are not directly connected to the surface of the force introduction element via the bonding forming during the hardening of component parts, can also transmit force to the projections 6 and thus to the force introduction element 4, resulting in a better utilization of the available material for the purpose of force transmission.

The pin-like form makes sure that the fibres of the composite fibre material of the encasing element 5 reliably lie in the distances between the projections 6 against the surface of the force introduction element 4 and neither can get stuck on the sides of the projections 6 in a raised position, nor can slide across the projections 6 under a tensile force.

In order to achieve a reliable connection, at least one circumferential row of projections 6 should be provided on the force introduction element 4. Furthermore, the projections 6 can be applied to the outer surface of the force introduction element 4 in the form of a regular pattern, for example, in circumferential rows offset from each other, in which the projections 6 of one row are in each case formed in the distances between the projections 6 of the previous row. Such an arrangement can be seen in FIG. 2. However, the projections 6 can also be arranged randomly on the surface of the force introduction element 4. They may exhibit a density gradient or, as shown in FIGS. 2 and 3, may be arranged with a constant density. Furthermore, it is possible to combine said features by providing, for example, an area of the force introduction element 4 with a dense, regular arrangement of projections 6 whereas, in at least one further area, only scattered projections 6 are provided.

The density of the projections is preferably at least 1 projection/cm². In the embodiment shown in FIGS. 2 and 3, the density of the projections is approx. 10 projections/cm².

In case of an integral construction with the force introduction element 4, the projections 6 consist of the same material as said element, but may also consist of other materials, depending on the requirements. Thus, projections 6 made of a welding wire of one steel grade may be arranged, for example, on a force introduction element 4 of a different steel grade.

In FIGS. 4A and 4B, a further exemplary embodiment of an arrangement 1 designed according to the invention is illustrated, wherein the elongate element 2 is made up of a plurality of individual elements, in particular of a plurality of pultruded rods 13.

The rods 13 may have their ends 14 radially bent outwards so that, in the cross-section, a radiated form will result, as is illustrated in FIG. 4A on the left-hand side in a strongly schematized manner.

If a force introduction element 4 is to be connected to a bundle of pultruded rods 13 in a known form, which is illustrated, e.g., in FIG. 2, this may also happen by means of an encasing element 5, whereby said element encases both the ends 14 of the pultruded rods 13 and the projections 6 of the force introduction element. The ends 14 of the rods 13, just like the projections 6, penetrate the fibre material of the encasing element 5 at least partially so that a secure and firm connection is possible also in this case.

1. An arrangement (1) for connecting an elongate element (2) used in particular for absorbing and/or transmitting tensile and/or torsional forces to a further component (3), comprising a force introduction element (4) with a side facing the further component (3) and a side facing away from the further component (3) and an encasing element (5) having a closed cross-section, said encasing element encasing the force introduction element (4) at least in some sections and projecting over the force introduction element (4) on its side which faces away from the further component (3), wherein projections (6) are provided on at least one section of the force introduction element (4) on its outer surface facing the encasing element (5), said projections penetrating the encasing element (5) at least partially, and the encasing element (5) consists essentially of a fibre composite material the fibre structure of which is produced in a braiding and/or winding process, wherein the fibres contained in the fibre composite material lie in continuous form at least partially in the regions formed between the projections (6), characterized in that the projections (6) are present in a dense, regular arrangement at least in one region of the force introduction element (4) and the ratio of the height of the projections (6) to the diameter of the projections (6) is greater than 1, preferably greater than 2, in particular 3 and more.

2. An arrangement according to claim 1, characterized in that the elongate element (2) consists of the same material as the encasing element (5) and is formed in one piece with the encasing element (5).

3. An arrangement according to claim 1, characterized in that the elongate element (2) is designed separately from the encasing element (5) and, in use, is surrounded by the encasing element (5) at least in some sections.

4. An arrangement according to claim 3, characterized in that the elongate element (2) likewise exhibits projections (6) at least in a part of the section surrounded by the encasing element (3), which projections penetrate the encasing element (5) at least partially.

5. An arrangement according to claim 3, characterized in that the elongate element (2) is designed as a bundle of several pultruded rods (13) and the projections (6) are formed by ends (14) of the individual rods (13) of the pultruded bundle of rods which are radially bent outwards.

6. An arrangement according to claim 1, characterized in that the projections (6) are shaped in the form of pins.

7. An arrangement according to claim 6, characterized in that the pins exhibit ball-shaped expansions on their outwardly projecting ends.

8. An arrangement according to claim 7, characterized in that the diameter of the projections shaped in the form of pins ranges between 0.3 mm and 3.5 mm, preferably between 0.5 mm and 2.5 mm, particularly preferably between 0.8 mm and 1.6 mm.

9. An arrangement according to claim 1, characterized in that at least one circumferential row of projections (6) is formed on the force introduction element (4) or on the elongate element (2), respectively.

10. An arrangement according to claim 1, characterized in that the projections (6) are distributed on the outer surface of the force introduction element (4) or the elongate element (2), respectively, in the form of a regular pattern and/or with a density gradient and/or with a constant density.

11. An arrangement according to claim 1, characterized in that the ratio of the distance between two projections (6) to the diameter of the projections (6) is greater than 1, preferably at least 3.

12. An arrangement according to claim 1, characterized in that the density of the projections is at least 1 projection/cm², preferably between 5 and 20 projections/cm², particularly preferably between 8 and 15 projections/cm².

13. An arrangement according to claim 1, characterized in that the projections (6) formed on the force introduction element (4) and on the elongate element (2), respectively, are formed in one piece with the force introduction element (4) or the elongate element (2), respectively, or are connected to the force introduction element (4) or the elongate element (2), respectively, by welding, soldering, bonding or screwing.

14. An arrangement according to claim 13, characterized in that the projections (6) are welded on according to the cold metal transfer process.

15. An arrangement according to claim 1, characterized in that an expander body (11) is provided which spreads apart the elongate element (2) on its end facing the force introduction element (4) and by means of which the elongate element (2) is clamped in use between the expander body (11) and the encasing element (5) and/or the force introduction element (4).

16. An arrangement according to claim 1, characterized in that the force introduction element (4) consists of a material selected from the group consisting of metal, plastic, fibre-reinforced plastic and ceramics.

17. An arrangement according to claim 1, characterized in that the fibre composite material consists of a material selected from the group consisting of fibre-reinforced plastic, fibre-reinforced metal and fibre-reinforced ceramics.

18. An arrangement according to claim 17, characterized in that the fibres used in the fibre composite material are selected from the group consisting of carbon fibre, glass fibre, aramide, boron fibre, ceramic fibre, basalt fibre, PBO or a combination of those fibres.

19. An arrangement according to claim 1, characterized in that the force introduction element (4) and/or the encasing element (5) taper(s) toward its side facing away from the further component (3).

20. An arrangement according to claim 1, characterized in that a connecting element (7) is provided on the end of the force introduction element (4) facing the further component (3).

21. An arrangement according to claim 20, characterized in that the connecting element (7) is an eye, a flange, a toothed wheel or a thread (8).

22. An arrangement according to claim 1, characterized in that the fibre composite material of the encasing element is built up of more than one layer of fibre material, in particular of two layers of fibre material.
